(19) United States
(12) Patent Application Publication
(10) Pub. No.: US 2025/0296241 A1
(43) Pub. Date: Sep. 25, 2025

(54) ROBOT CONTROL APPARATUS, ROBOT, ROBOT CONTROL METHOD, AND RECORDING MEDIUM

(71) Applicant: CASIO COMPUTER CO., LTD., Tokyo (JP)

(72) Inventors: Hirokazu HASEGAWA, Tokyo (JP); Erina ICHIKAWA, Tokyo (JP); Kouki MAYUZUMI, Tokyo (JP)

(73) Assignee: CASIO COMPUTER CO., LTD., Tokyo (JP)

(21) Appl. No.: 19/085,370

(22) Filed: Mar. 20, 2025

(30) Foreign Application Priority Data
Mar. 22, 2024 (JP) 2024-046771

(51) Int. Cl. B25J 13/00

(52) U.S. Cl. CPC B25J 13/003

(57) ABSTRACT

Disclosed is a robot control apparatus including one or more processors configured to: determine, in a predetermined manner, a state of a robot including a sensor that detects a stimulus from outside; cause the robot to perform a reactive action corresponding to the stimulus in a case in which the sensor detects the stimulus and the robot is in a predetermined state; and cause the robot not to perform the reactive action corresponding to the stimulus in a case in which the sensor detects the stimulus, the stimulus satisfies a predetermined condition, and the robot is not in the predetermined state.

### REFERENCE TO RELATED APPLICATIONS

This application claims the priority and benefits of Japanese Patent Application No. 2024-046771, filed on Mar. 22, 2024. The specification, claims, and drawings of Japanese Patent Application No. 2024-046771 are incorporated herein by reference in their entirety.

### TECHNICAL FIELD

The present disclosure relates to a robot control apparatus, a robot, a robot control method, and a recording medium.

### DESCRIPTION OF RELATED ART

There has been known a technology that causes a robot to perform a predetermined reactive action in response to an external stimulus such as a user's call (for example, JP 2003-326479A).

### SUMMARY OF THE INVENTION

A robot control apparatus reflecting one aspect of the present invention comprises one or more processors configured to: determine, in a predetermined manner, a state of a robot including a sensor that detects a stimulus from outside; cause the robot to perform a reactive action corresponding to the stimulus in a case in which the sensor detects the stimulus and the robot is in a predetermined state; and cause the robot not to perform the reactive action corresponding to the stimulus in a case in which the sensor detects the stimulus, the stimulus satisfies a predetermined condition, and the robot is not in the predetermined state.

### BRIEF DESCRIPTION OF DRAWINGS

The advantages and features provided by one or more embodiments of the invention will become more fully understood from the detailed description given hereinbelow and the appended drawings which are given by way of illustration only, and thus are not intended as a definition of the limits of the present invention, wherein:

FIG. 1 is a diagram illustrating an appearance of a robot;

FIG. 2 is a schematic diagram illustrating a configuration of a main body of the robot;

FIG. 3 is a block diagram illustrating a functional configuration of the robot;

FIG. 4 is a schematic cross-sectional view of the robot stored and charged in a power feeder;

FIG. 5 is a diagram illustrating an overview of actions of the robot in each operation mode;

FIG. 6 is a flowchart illustrating a control procedure of an action control process;

FIG. 7 is a flowchart illustrating a control procedure of a sound reaction process;

FIG. 8 is a flowchart illustrating a control procedure of a sleep mode control process;

FIG. 9 is a flowchart illustrating a control procedure of a contact reaction process according to a variation 1;

FIG. 10 is a flowchart illustrating a control procedure of the sound reaction process according to a variation 2;

FIG. 11 is a flowchart illustrating a control procedure of the contact reaction process according to a variation 3; and

FIG. 12 is a flowchart illustrating a control procedure of the action control process according to a variation 4.

### DETAILED DESCRIPTION

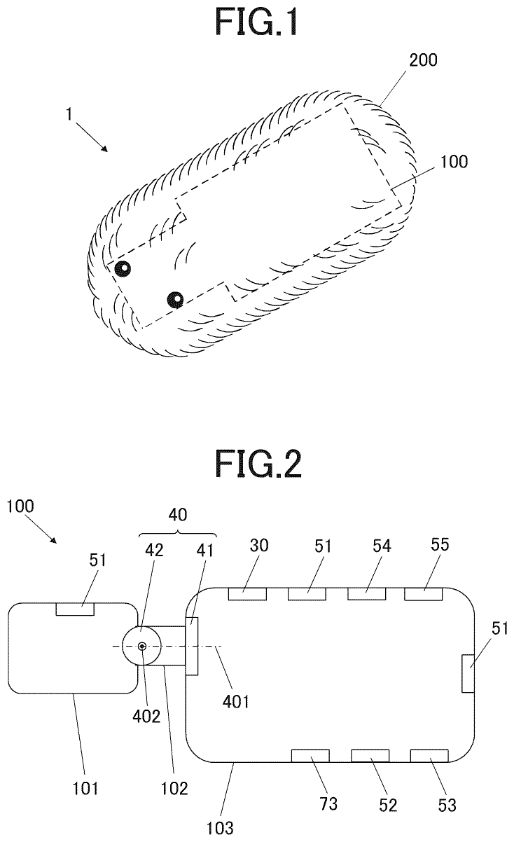

Hereinafter, one or more embodiments according to the present disclosure will be described with reference to the drawings. As illustrated in FIG. 1, a robot 1 includes a main body 100 and an exterior 200 that covers the main body 100. The robot 1 is a pet robot modeled after a small creature. The robot 1 can perform a plurality of different actions that imitate the gestures of a living being. The exterior 200 deforms in accordance with the movement of the main body 100. The exterior 200 includes fur formed from pile fabric, decorative components imitating eyes, and the like.

As illustrated in FIG. 2, the main body 100 of the robot 1 includes a head 101, a torso 103, and a connector 102 that connects the head 101 and the torso 103. The main body 100 includes a drive unit 40 that moves the head 101 relative to the torso 103. The drive unit 40 includes a twisting motor 41 and a up-and-down movement motor 42. The twisting motor 41 is a servo motor that rotates the head 101 and the connector 102 within a predetermined angle range around a first rotating shaft 401 extending in the extending direction of the connector 102. The twisting motor 41 enables the robot 1 to twist the head 101. The up-and-down movement motor 42 is a servo motor that rotates the head 101 within a predetermined angle range around a second rotation axis 402 perpendicular to the first rotation axis 401. The up-and-down movement motor 42 enables the robot 1 to move the head 101 up and down. The up-and-down movement direction of the head 101 can also be inclined with respect to the vertical direction depending on a twisting angle of the head 101 by the twisting motor 41. By operating the twisting motor 41 and/or the up-and-down movement motor 42 in a fine, periodic manner, the robot 1 can swing or shake the head 101. By suitably changing and combining the timings, amounts, and speeds of the operations of the twisting motor 41 and the up-and-down movement motor 42, it is possible to cause the robot 1 to perform various actions, such as an action of joy, an action of surprise, and a breathing action that imitates the breathing of a living being (spontaneous action).

The main body 100 includes touch sensors 51, an acceleration sensor 52, a gyro sensor 53, an illuminance sensor 54, a microphone 55, a sound output unit 30, and a power reception coil 73. The touch sensors 51 are disposed at the top of the head 101, as well as at the top, side, and the like of the torso 103. The illuminance sensor 54, microphone 55, and sound output unit 30 are disposed at top of the torso 103. The acceleration sensor 52 and the gyro sensor 53 are disposed at the bottom of the torso 103. The power reception coil 73 is disposed adjacent to the bottom surface of the torso 103.

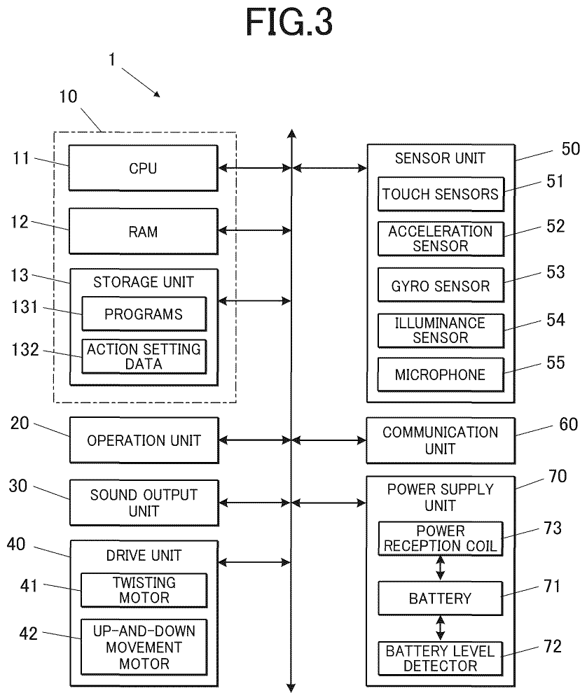

As illustrated in FIG. 3, the robot 1 includes a central processing unit (CPU) 11, a random-access memory (RAM) 12, a storage unit 13, an operation unit 20, a sound output unit 30, a drive unit 40, a sensor unit 50, a communication unit 60, and a power supply unit 70. The components of the robot 1 are coupled to each other via a communication path such as a bus. Each functional configuration illustrated in FIG. 3 is provided in the main body 100. A robot control apparatus 10 that controls actions of the robot 1 includes the CPU 11, RAM 12, and storage unit 13.

The CPU 11 is a processor (processing unit, processing means) that reads and executes programs 131 stored in the storage unit 13 to perform various arithmetic processing, thereby controlling the actions of the robot 1. The robot 1 may include a plurality of processors (e.g., a plurality of CPUs), and the plurality of processors may execute a plurality of processes executed by the CPU 11 according to the present embodiment. In this case, the plurality of processors serves as one or more processors. In addition, the plurality of processors may be involved in a common process, or the plurality of processors may independently execute different processes in parallel. The RAM 12 provides a working memory space for the CPU 11 and stores temporary data.

The storage unit 13 is a non-transitory recording medium readable by the CPU 11 serving as a computer and stores the programs 131 and various data. The storage unit 13 includes, for example, a nonvolatile memory such as a flash memory. Each of the programs 131 is stored in the storage unit 13 in a form of a computer-readable program code. The data stored in the storage unit 13 includes action setting data 132, and the like. The action setting data 132 sets action contents, such as a reactive action that the robot 1 performs in response to the state of the robot 1 or an external stimulus, and a whimsical action that the robot 1 spontaneously performs regardless of an external stimulus. The settings related to the action contents includes, for example, the settings of the operation timing and the operation amount of the twisting motor 41 and up-and-down movement motor 42 of the drive unit 40, the settings of the pitch, the length, and the volume of a sound output by the sound output unit 30, and the like.

The operation unit 20 includes operation buttons, operation knobs, and the like for turning the power on and off, as well as for adjusting the volume of a sound output by the sound output unit 30. The operation unit 20 outputs operation information to the CPU 11 according to an input operation on the operation buttons and the operation knobs. The sound output unit 30 includes a speaker and outputs a sound at a pitch, length, and volume corresponding to a control signal and sound data transmitted from the CPU 11. The sound may be a sound that imitates the cry of a living being. The drive unit 40 operates the twisting motor 41 and the up-and-down movement motor 42 according to a control signal transmitted from the CPU 11.

The sensor unit 50 includes the touch sensors 51, acceleration sensor 52, gyro sensor 53, illuminance sensor 54, and microphone 55, and outputs detection results from the sensors and the microphone 55 to the CPU 11. The touch sensors 51, acceleration sensor 52, gyro sensor 53, illuminance sensor 54, and microphone 55 correspond to “sensors that detect an external action.” The touch sensors 51 detect a contact of a user or another object with the robot 1. Each of the touch sensors 51 includes, for example, a pressure sensor or a capacitance sensor, and outputs detection data regarding the presence or absence of a contact with the robot 1 to the CPU 11. When the touch sensor 51 includes a pressure sensor, the touch sensor 51 outputs the intensity of the contact with the robot 1 to the CPU 11. The acceleration sensor 52 detects acceleration in each of three orthogonal axial directions and outputs detection data to the CPU 11. The gyro sensor 53 detects the angular velocity around each of the three orthogonal axial directions and outputs detection data to the CPU 11. The illuminance sensor 54 detects brightness around the robot 1 and outputs detection data to the CPU 11. The microphone 55 detects a sound around the robot 1 and outputs detected sound data to the CPU 11.

The communication unit 60 is a communication module that includes an antenna, modulation/demodulation circuit, signal processing circuit, and the like, and performs wireless data communication with an external device according to a predetermined communication standard.

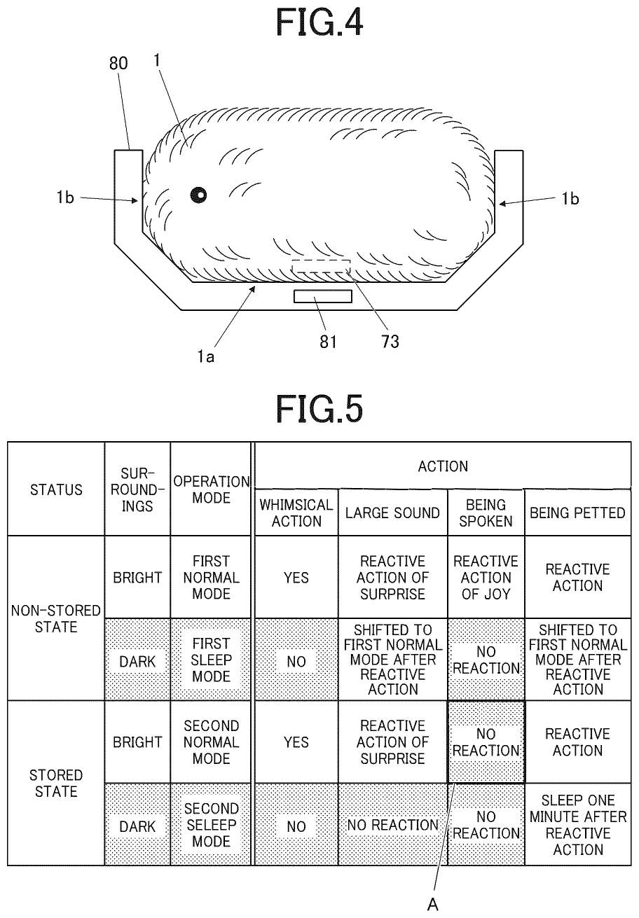

The power supply unit 70 includes a battery 71, a battery level detector 72, and a power reception coil 73. The battery 71 supplies power to each component of the robot 1. The battery 71 according to the present embodiment is a secondary battery that can be repeatedly charged by a non-contact charging method. The battery level detector 72 detects the battery level of the battery 71 according to a control signal transmitted from the CPU 11 and outputs a detection result to the CPU 11. As illustrated in FIG. 4, the battery 71 is charged while the robot 1 is stored (installed) in a dedicated power feeder 80 (holder, charging dock). FIG. 4 illustrates a cross-section of the power feeder 80 and a side view of the robot 1 for descriptive purposes. The power feeder 80 has an appearance modeled after a house of the robot 1. The power feeder 80 is a holder having substantially the same length and width as the outer shape of the robot 1. The power feeder 80 has an opening at the top, and the robot 1 can be taken in and out through the opening. The power feeder 80 has a shape that contacts the bottom surface la of the robot 1 and at least a portion of the side surface 1b of the robot 1 when the robot 1 is stored therein. A power transmission coil 81 is disposed in the bottom of the power feeder 80, in a position facing the power reception coil 73 when the robot 1 is stored in the power feeder 80. When the power feeder 80 detects that the robot 1 has been stored therein, the power feeder 80 causes an electric current to flow through the power transmission coil 81 to generate a magnetic field. The power reception coil 73 of the robot 1 supplies an electric current generated by electromagnetic induction in response to the generated magnetic field to the battery 71. With this configuration, when the robot 1 is stored in the power feeder 80, the charging of the battery 71 is automatically started. The charging method for the battery 71 is not limited to the non-contact charging method and may be a contact charging method in which a charging terminal of the robot 1 is brought into contact with a charging terminal of the power feeder 80.

Next, an operation of the robot 1 will be described with reference to FIG. 5. When the surroundings are bright (when a predetermined brightness condition is met), the robot 1 operates in a normal mode that simulates being active. When the surroundings are dark (when the brightness condition is not met), the robot 1 operates in a sleep mode that simulates sleeping or resting. When the illuminance detected by the illuminance sensor 54 is greater than or equal to a predetermined reference illuminance, the CPU 11 determines that the brightness condition is met, meaning that the surroundings are bright. When the illuminance detected by the illuminance sensor 54 is less than the reference illuminance, the CPU 11 determines that the brightness condition is not met, meaning that the surroundings are dark. In addition, the robot 1 performs different actions depending on whether the robot 1 is in a non-stored state (a predetermined state, a first state) in which the robot 1 is outside the power feeder 80, or in a stored state (a state different from the predetermined state, a second state) in which the robot 1 is stored in the power feeder 80. When the power supply unit 70 is not charging the battery 71, the CPU 11 determines that the robot 1 is in the non-stored state. When the power supply unit 70 is charging the battery 71 by the action of the power reception coil 73, the CPU 11 determines that the robot 1 is in the stored state. Alternatively, the CPU 11 may determine whether the robot 1 is in the stored state by other means. For example, a magnet may be disposed on an inner wall of the power feeder 80, and a magnetic sensor may be disposed at a position where a magnetic field of the magnet can be detected when the robot 1 is stored in the power feeder 80, and the CPU 11 may determine whether the robot 1 is in the stored state based on whether the magnetic sensor detects the magnetic field. Thus, the determination of whether the robot 1 is in the stored state is not necessarily based on whether the battery 71 is currently being charged. The “stored state” may be referred to as an “installed state”, and the “non-stored state” as a “non-installed state”. The CPU 11 causes the robot 1 to operate in a first normal mode when the robot 1 is in the non-stored state and the surroundings are bright. The CPU 11 causes the robot 1 to operate in a first sleep mode when the robot 1 is in the non-stored state and the surroundings are dark. The CPU 11 causes the robot 1 to operate in a second normal mode when the robot 1 is in the stored state and the surroundings are bright. The CPU 11 causes the robot 1 to operate in a second sleep mode when the robot 1 is in the stored state and the surroundings are dark. The operation setting for each operation mode in FIG. 5 is stored in the action setting data 132.

In the first normal mode, the CPU 11 causes the robot 1 to perform a predetermined whimsical action set in the action setting data 132 when the execution condition for the whimsical action is met. The execution condition for the whimsical action may be, for example, that there has been no external stimulus for a predetermined time, but is not limited thereto. A plurality of whimsical actions may be set, and the CPU 11 may cause the robot 1 to perform an action randomly selected from the plurality of whimsical actions.

In the first normal mode, when a large sound has been detected as an external stimulus, the CPU 11 causes the robot 1 to perform a reactive action of surprise preset in the action setting data 132. The CPU 11 determines that a large sound has been detected when a sound with a volume greater than a predetermined reference range is detected by the microphone 55.

In the first normal mode, when a voice of a user speaking to the robot 1 (hereinafter, referred to as “spoken voice”) has been detected as an external stimulus, the CPU 11 causes the robot 1 to perform a reactive action of joy preset in the action setting data 132. The CPU 11 determines that a spoken voice has been detected when a sound with a volume within the reference range is detected by the microphone 55. Alternatively, the CPU 11 may determine that a spoken voice has been detected when a sound with a volume within the reference range is detected over a predetermined time period. The reference range of the sound volume is defined to include the volume of a voice of a user speaking to the robot 1. In other words, the upper limit of the reference range of the sound volume (referred to as a “first volume threshold”) is set to be greater than the volume of a spoken voice. In the present embodiment, the lower limit of the reference range of the sound volume (referred to as a “second volume threshold”) is zero. However, the second volume threshold may be set to be greater than zero so that the robot 1 does not respond to a sound with a volume below the second volume threshold. The reference range of the sound volume is preset and stored in the action setting data 132. The first and second volume thresholds may be changeable by a user operation.

In the first normal mode, when the CPU detects, as an external stimulus, that the robot 1 has been petted, the CPU 11 causes the robot 1 to perform a predetermined reactive action preset in the action setting data 132. The CPU 11 determines that the robot 1 has been petted when a contact with an intensity within a predetermined reference range is detected by the touch sensors 51.

Although not shown in FIG. 5, in the first normal mode, the CPU 11 causes the robot 1 to repeatedly perform the aforementioned breathing action at a predetermined frequency. This allows the robot 1 to appear more like a living being. When the CPU 11 detects a stimulus not shown in FIG. 5, the CPU 11 may cause the robot 1 to perform a reactive action in response to the stimulus. Stimuli not shown in FIG. 5 include, for example, lifting or holding of the robot 1 detected by the acceleration sensor 52 and/or the gyro sensor 53.

In the first sleep mode, the CPU 11 does not cause the robot 1 to perform any of the whimsical action or the reactive action in response to a spoken voice. In FIG. 5, the cases in which the CPU 11 does not cause the robot 1 to perform the whimsical action or the reactive actions are colored with dots. Thus, in the first sleep mode, by not causing the robot 1 to perform some of the reactive actions, it is expressed that the robot 1 is sleeping or resting. On the other hand, in the first sleep mode, when a large sound has been detected or when a petting of the robot 1 has been detected, the CPU 11 causes the robot 1 to perform a reactive action similar to that in the first normal mode and then shifts the operation mode to the first normal mode. This simulates a scenario where the robot 1 wakes up when the robot 1 hears a large sound or is petted while sleeping. Also in the first sleep mode, the CPU 11 causes the robot 1 to repeatedly perform the breathing action at a predetermined frequency as in the first normal mode.

In the second normal mode, in which the robot 1 is stored and charged in the power feeder 80, the CPU 11 causes the robot 1 to perform the breathing action. This causes the inner wall of the power feeder 80 to rub against (contact) the side surface 1b of the robot 1, thereby generating a sound. Hereinafter, this sound will be referred to as “rubbing sound”. The rubbing sound is normally detected by the microphone 55 as a sound with a volume less than or equal to the volume of a spoken voice. For this reason, if the robot 1 is controlled in the stored state in the same way as in the first normal mode, when the rubbing sound is detected, the robot 1 will perform the reactive action in response to a spoken voice. This makes the robot 1 appear to be performing the reactive action of joy, even though the user is not speaking to the robot 1, which looks unnatural to the user. Therefore, in the second normal mode in the stored state, even when a spoken voice is detected (that is, even when a sound with a volume within the reference range is detected), the CPU 11 does not cause the robot 1 to perform a reactive action according to the sound (action A in FIG. 5). In other words, when a sound with a volume within the reference range is detected in the second normal mode, the CPU 11 determines that the sound is the rubbing sound and does not cause the robot 1 to perform a reactive action. This makes it possible to prevent the robot 1 from performing an unnatural action even when the rubbing sound is detected. A sound with a volume within the reference range is one aspect of a “stimulus that satisfies a predetermined condition” and a “stimulus with an intensity within the reference range”. As described above, the reference range of the sound volume is defined to include the volume of a spoken voice. However, the range of the volume of the rubbing sound can be wider than the range of the volume of a spoken voice. In this case, the reference range of the sound volume is defined to include the range of the volume of the rubbing sound. In the second normal mode, actions are the same as those in the first normal mode except that the robot 1 does not perform a reactive action in response to a spoken voice.

In the second sleep mode, as in the first sleep mode, the CPU 11 does not cause the robot 1 to perform any of the whimsical action or the reactive action in response to a spoken voice. Furthermore, the CPU 11 does not cause the robot 1 to perform a reactive action even when a large sound has been detected. This expresses that in the second sleep mode, in which the robot 1 is stored in the power feeder 80, the robot 1 is in a deeper sleep than in the first sleep mode. On the other hand, when the CPU 11 detects that the robot 1 has been petted in the second sleep mode, the CPU 11 causes the robot 1 to perform a reactive action and then to operate in the second normal mode only for a predetermined temporary awakening time (one minute in the present embodiment). When the temporary awakening time elapses, the CPU 11 returns the operation mode of the robot 1 to the second sleep mode. This simulates a scenario where when the robot 1 is stored and charged in the power feeder 80 and the surroundings are dark, even if the robot 1 is petted, the robot 1 will temporarily wake up and then return to sleep. In the first and second sleep modes, the robot 1 does not respond to a spoken voice (a sound with a volume within the reference range). This prevents the robot 1 from performing an unnatural action in response to the rubbing sound due to the breathing action.

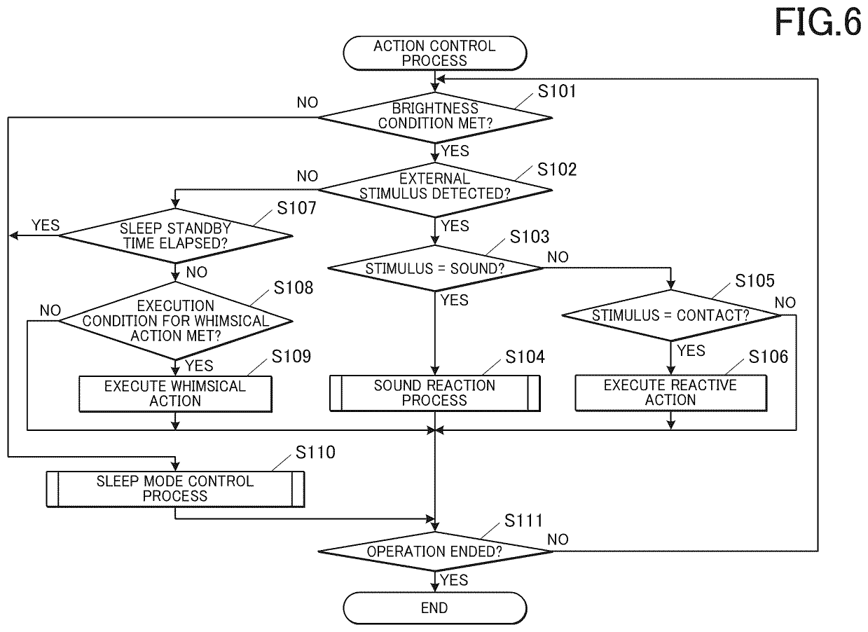

Next, an action control process executed by the CPU 11 in order to realize each action in FIG. 5 will be described with reference to FIGS. 6 to 8. The action control process is started when the robot 1 is powered on to be activated. Although not shown in FIG. 6, the CPU 11 causes the robot 1 to perform the breathing action at a predetermined frequency while the action control process is being executed. The CPU 11 may cause the robot 1 to perform the breathing action only when the robot 1 is stored in the power feeder 80 to be in the stored state. As illustrated in FIG. 6, when the action control process is started, the CPU 11 determines whether the brightness condition mentioned above is satisfied based on a detection result of the illuminance by the illuminance sensor 54 (step S101). If the CPU 11 determines that the brightness condition is satisfied (that is, the surroundings are bright) (“YES” in step S101), the CPU 11 causes the robot 1 to operate in the first normal mode or the second normal mode by executing the subsequent steps S102 to S109 and S111. As will be described later, the first normal mode and the second normal mode differ only in part of a sound reaction process in step S104. The CPU 11 determines whether an external stimulus has been detected based on detection results by the touch sensors 51 and the microphone 55 (step S102). If the CPU 11 determines that a stimulus has been detected (“YES” in step S102), the CPU 11 determines whether the stimulus is a sound (step S103). If the CPU 11 determines that the stimulus is a sound (“YES” in step S103), the CPU 11 executes the sound reaction process (step S104).

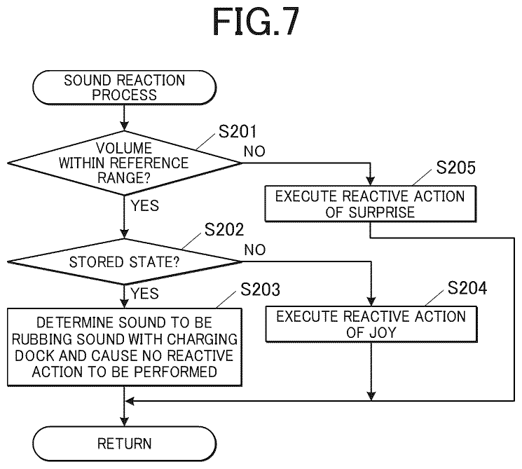

As illustrated in FIG. 7, when the sound reaction process is started, the CPU 11 determines whether the volume of the detected sound is within the reference range (step S201). If the CPU 11 determines that the volume is within the reference range (“YES” in step S201), the CPU 11 determines whether the robot 1 is in the stored state based on the status of the power supply unit 70 (that is, whether the robot 1 is operating in the second normal mode) (step S202). If the CPU 11 determines that the robot 1 is in the stored state (“YES” in step S202), the CPU 11 determines that the sound detected in step S103 is the rubbing sound according to the setting of the second operation mode and does not cause the robot 1 to perform a reactive action in response to the sound (step S203). That is, the CPU 11 does not transmit a control signal for operating the drive unit 40 or the sound output unit 30. On the other hand, if the CPU 11 determines that the robot 1 is in the non-stored state (“NO” in step S202), the CPU 11 determines that the sound detected in step S103 is a spoken voice according to the setting of the first operation mode and causes the robot 1 to perform a reactive action of joy (step S204). Here, the CPU 11 refers to the action setting data 132 to identify the content of the reactive action of joy and transmits a control signal for causing the robot 1 to perform the action to the drive unit 40 and the sound output unit 30. In the first and second normal modes, the only difference is that step S204 is executed in the first normal mode, while step S203 is executed in the second normal mode; all other processes are the same.

On the other hand, if the CPU 11 determines that the volume is greater than the reference range (“NO” in step S201), the CPU 11 causes the robot 1 to perform a reactive action of surprise (step S205). Here, the CPU 11 refers to the action setting data 132 to identify the content of the reactive action of surprise and transmits a control signal for causing the robot 1 to perform the action to the drive unit 40 and the sound output unit 30. The processing of step S205 is executed regardless of whether the robot 1 is in the stored state or the non-stored state. Therefore, when the robot 1 is in the stored state (the second state) and a stimulus that does not satisfy the predetermined condition is detected, the processing of step S205 corresponds to a process of causing the robot 1 to perform a reactive action according to the stimulus. When any of steps S203 to S205 is completed, the CPU 11 ends the sound reaction process and return the process to the action control process illustrated in FIG. 6.

If the CPU 11 determines that the detected stimulus is not a sound (“NO” in step S103) and determines that the stimulus is a contact (“YES” in step S105), the CPU 11 causes the robot 1 to perform a predetermined reactive action according to the contact (step S106). Here, the CPU 11 refers to the action setting data 132 to identify the content of the reactive action according to the contact and transmits a control signal for causing the robot 1 to perform the action to the drive unit 40 and the sound output unit 30. If the CPU 11 determines that the stimulus is not a contact (“NO” in step S105), the CPU 11 moves the process to step S111 without causing the robot 1 to perform any reactive action.

If the CPU 11 determines in step S102 that no stimulus has been detected (“NO” in step S102), the CPU 11 determines whether a predetermined sleep standby time has elapsed without detection of an external stimulus (step S107). The sleep standby time may be set to about 2 hours, for example. If the CPU 11 determines that the sleep standby time has not elapsed (“NO” in step S107), the CPU 11 determines whether the execution condition for a whimsical action is satisfied (step S108). For example, the CPU 11 determines that the execution condition for a whimsical action is satisfied when no external stimulus has been detected for a predetermined time. In this case, the predetermined time is set to be shorter than the sleep standby time. If the CPU 11 determines that the execution condition for a whimsical action is satisfied (“YES” in step S108), the CPU 11 causes the robot 1 to perform a predetermined whimsical action (step S109). Here, the CPU 11 refers to the action setting data 132 to identify the content of the whimsical action and transmits a control signal for causing the robot 1 to perform the action to the drive unit 40 and the sound output unit 30.

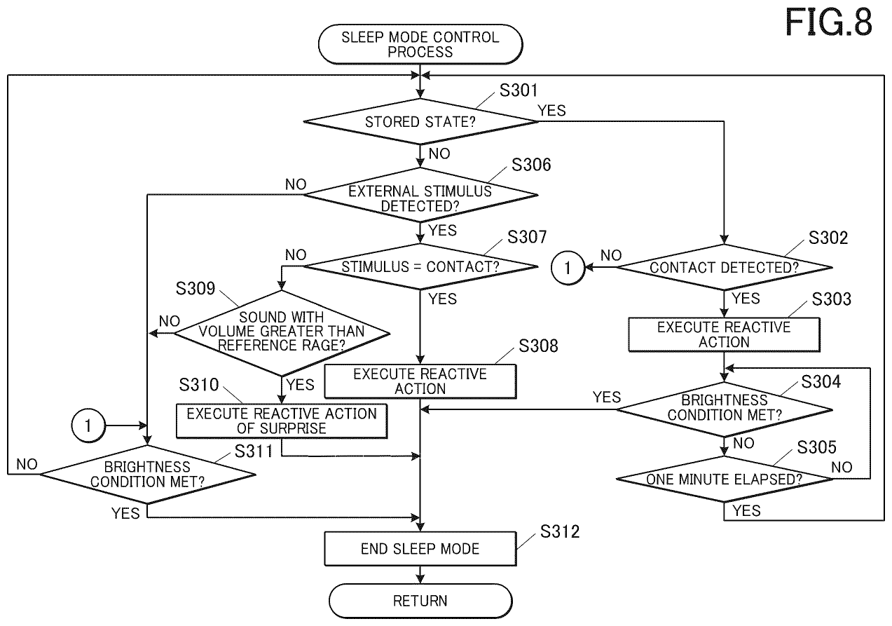

If the CPU 11 determines in step $101 that the brightness condition is not satisfied (that is, the surroundings are dark) (“NO” in step S101), or if the CPU 11 determines in step S107 that the sleep standby time has elapsed (“YES” in step S107), the CPU 11 executes a sleep mode control process. As illustrated in FIG. 8, when the sleep mode control process is started, the CPU 11 determines whether the robot 1 is in the stored state (step S301). If the CPU 11 determines that the robot 1 is in the stored state (“YES” in step S301), the CPU 11 executes steps S302 to S305 to cause the robot 1 to operate in the second sleep mode. In the second sleep mode, the CPU 11 determines whether a contact as an external stimulus has been detected (step S302). If the CPU 11 determines that no contact has been detected (“NO” in step S302), the CPU 11 moves the process to step S311 without causing the robot 1 to perform any reactive action. Thus, in the second sleep mode, the robot 1 does not respond to stimuli other than a contact. Therefore, the robot 1 does not respond to any sound that includes a spoken voice. If the CPU 11 determines that a contact has been detected (“YES” in step S302), the CPU 11 executes steps S303 to S305 to cause the robot 1 to perform actions related to temporary awakening of the robot 1. That is, the CPU 11 causes the robot 1 to perform a predetermined reactive action according to a contact (step S303). Then, the CPU 11 determines whether the brightness condition is satisfied based on a detection result of the illuminance by the illuminance sensor 54 (step S304). If the CPU 11 determines that the brightness condition is satisfied (“YES” in step S304), the CPU 11 ends the sleep mode (step S312) and returns the process to the action control process in FIG. 6. If the CPU 11 determines that the brightness condition is not satisfied (“NO” in step S304), the CPU 11 determines whether a temporary awakening time (in this case, one minute) has elapsed after the robot performing the reactive action (step S305). If the CPU determines that the temporary awakening time has not elapsed (“NO” in step S305), the CPU 11 returns the process to step S304. If the CPU 11 determines that the temporary awakening time has elapsed (“YES” in step S305), the CPU 11 returns the process to step S301 and continues the sleep mode control process.

In step S301, if the CPU 11 determines that the robot 1 is in the non-stored state (“NO” in step S301), the CPU 11 executes steps S306 to S311 to cause the robot 1 to operate in the first sleep mode. In the first sleep mode, the CPU 11 determines whether an external stimulus has been detected based on detection results by the touch sensors 51 and the microphone 55 (step S306). If the CPU 11 determines that a stimulus has been detected (“YES” in step S306) and determines that the stimulus is a contact (“YES” in step S307), the CPU 11 causes the robot 1 to perform a predetermined reactive action according to the contact (step S308). If the CPU 11 determines that the stimulus is not a contact (“NO” in step S307), the CPU 11 determines whether the stimulus is a large sound (a sound with a volume greater than the reference range) (step S309). If the CPU 11 determines that the stimulus is a large sound (“YES” in step S309), the CPU 11 causes the robot 1 to perform a reactive action of surprise (step S310). If the CPU 11 determines that the stimulus is not a large sound (“NO” in step S309), the CPU 11 moves the process to step S311 without causing the robot 1 to perform any reactive action. Therefore, in the first sleep mode, the robot 1 does not respond to a spoken voice. The processing of step S308 or S310 simulates a scenario where the robot 1 wakes up in response to a stimulus. Therefore, when step S308 or S310 is completed, the CPU 11 ends the sleep mode (step S312) and returns the process to the action control process in FIG. 6. On the other hand, if the process branches to “NO” in step S306 or S309, the CPU 11 determines whether the brightness condition is satisfied (step S311). If the CPU 11 determines that the brightness condition is not satisfied (“NO” in step S311), the CPU 11 returns the process to step S301 and continues the sleep mode control process. If the CPU 11 determines that the brightness condition is satisfied (“YES” in step S311), the CPU 11 ends the sleep mode (step S312) and returns the process to the action control process in FIG. 6.

In FIG. 6, if any of steps S104, S106, S109, or S110 is completed, or if the process branches to “NO” in step S105 or S108, the CPU 11 determines whether a user operation to end the operation of the robot 1 (for example, an operation to turn off the power) has been performed (step S111). If the CPU 11 determines that the user operation has not been performed (“NO” in step S111), the CPU 11 returns the process to step S101. If the CPU 11 determines that the user operation has been performed (“YES” in step S111), the CPU 11 ends the action control process.

Next, a variation 1 of the above-described embodiment will be described. Hereinafter, differences from the above-described embodiment will be described. In the above embodiment, when the CPU 11 detects a sound with a volume within the reference range in the second normal mode, the CPU 11 does not cause the robot 1 to perform a reactive action, thereby preventing the robot 1 from performing an unnatural action in response to the rubbing sound. In the variation 1, in addition to (or instead of) the action control based on a sound, in the second normal mode, when a contact as an external stimulus satisfies a predetermined condition, the CPU 11 does not cause the robot 1 to perform a reactive action, thereby preventing the robot 1 from performing an unnatural action in response to a contact with the power feeder 80. The predetermined condition regarding a contact may be met, for example, when the intensity of the contact detected by the touch sensor 51 is within a predetermined reference range. In this case, the reference range of the contact intensity is defined to include the intensity of the contact between the power feeder 80 and the side surface 1b of the robot 1 caused by the breathing action of the robot 1 while the robot 1 is stored in the power feeder 80. In other words, the first intensity threshold, which is the upper limit of the reference range of the contact intensity, is set to be greater than the intensity of the contact with the power feeder 80. In the present embodiment, the second intensity threshold, which is the lower limit of the reference range of the contact intensity, is zero. However, the second intensity threshold may be set to be greater than zero so that the robot 1 does not respond to a contact with an intensity below the second intensity threshold. The reference range of the contact intensity is preset and stored in the action setting data 132. The first and second intensity thresholds may be changeable by a user operation.

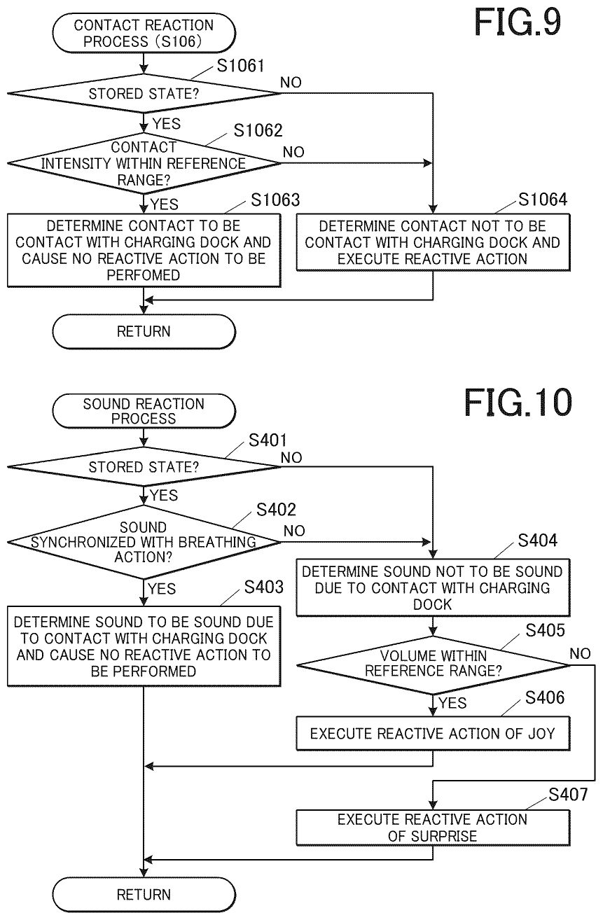

In the variation 1, instead of step S106 in the action control process in FIG. 6, a contact reaction process illustrated in FIG. 9 is executed. When the contact reaction process is started, the CPU 11 determines whether the robot 1 is in the stored state based on the status of the power supply unit 70 (step S1061). If the CPU 11 determines that the robot 1 is in the stored state (“YES” in step S1061), the CPU 11 determines whether the intensity of the contact detected in step S105 in FIG. 6 is within the reference range based on a detection result by the touch sensor 51 (step S1062). If the CPU 11 determines that the intensity of the contact is within the reference range (“YES” in step S1062), the CPU 11 determines that the detected contact is with the power feeder 80 according to the setting of the second operation mode and does not cause the robot 1 to perform a reactive action in response to the contact (step S1063). On the other hand, if the CPU 11 determines that the robot 1 is in the non-stored state (“NO” in step S1061), or if the CPU 11 determines that the intensity of the contact is greater than the reference range (“NO” in step S1062), the CPU 11 determines that the detected contact is not with the power feeder 80 and causes the robot 1 to perform a predetermined reactive action according to the contact (step S1064). When step S1063 or S1064 is completed, the CPU 11 ends the contact reaction process and moves the process to step S111 in FIG. 6. In FIG. 9, the processing of step S1064 executed after the process branches to “NO” in step S1061 corresponds to the processing of the first normal mode, and the processing of steps S1062 to S1064 executed after the process branches to “YES” in step S1061 correspond to the processing of the second normal mode.

Next, a variation 2 of the above-described embodiments will be described. Hereinafter, differences from the above-described embodiments will be described. The rubbing sound caused by the contact with the power feeder 80 is generated at a timing synchronized with the breathing action of the robot 1. Therefore, in the second normal mode, when a sound is detected at a timing synchronized with the breading action, the CPU 11 according to the variation 2 determines that the sound satisfies a predetermined condition and does not cause the robot 1 to perform a reactive action according to the sound.

In the variation 2, instead of the sound reaction process illustrated in FIG. 7, a sound reaction process illustrated in FIG. 10 is executed. When the sound reaction process in FIG. 10 is started, the CPU 11 determines whether the robot 1 is in the stored state based on the status of power supply unit 70 (step S401). If the CPU 11 determines that the robot 1 is in the stored state (“YES” in step S401), the CPU 11 determines whether the sound detected by the microphone 55 in step S103 in FIG. 6 is detected at a timing synchronized with the breathing action of the robot 1 based on a detection result of the sound by the microphone 55 and the timing of the breathing action of the drive unit 40 (step S402). For example, when a sound is detected by the microphone 55 within a predetermined time after transmitting a control signal related to the breathing action to the drive unit 40, the CPU 11 determines that the sound is detected at a timing synchronized with the breathing action. The predetermined time is set to approximately the duration of one breathing action. If the CPU 11 determines that the sound is detected at a timing synchronized with the breathing action (“YES” in step S402), the CPU 11 determines that the detected sound is the rubbing sound caused by the contact with the power feeder 80 according to the setting of the second operation mode, and does not cause the robot 1 to perform a reactive action in response to the detected sound (step S403).

On the other hand, if the CPU 11 determines that the robot 1 is in the non-stored state (“NO” in step S401), or if the CPU 11 determines that the detected sound is not synchronized with the breathing action (“NO” in step S402), the CPU 11 determines that the detected sound is not the rubbing sound caused by the contact with the power feeder 80 (step S404). The CPU 11 determines whether the volume of the detected sound is within the reference range (step S405). If the CPU 11 determines that the volume is within the reference range (“YES” in step S405), the CPU 11 determines that the sound is a spoken voice and causes the robot 1 to perform a reactive action of joy (step S406). If the CPU 11 determines that the volume is greater than the reference range (“NO” in step S405), the CPU 11 determines that the sound is a large sound and causes the robot 1 to perform a reactive action of surprise (step S407). When any of steps S403, S406, or S407 is completed, the CPU 11 ends the sound reaction process and returns the process to the action control process in FIG. 6. In FIG. 10, the steps $404 to S407 executed after the process branches to “NO” in step S401 correspond to the processing of the first normal mode, while the steps S402 to S407 executed after the process branches to “YES” in step S401 correspond to the processing of the second normal mode. In addition, step $401 in FIG. 10 may be omitted, and whether to execute a reactive action may be determined simply based on the determination result (in step S402) of whether a sound synchronized with the breathing action is detected.

Next, a variation 3 of the above-described embodiments will be described. Hereinafter, differences from the above-described embodiments will be described. The variation 3 may be combined with the variation 2. The contact with the power feeder 80 in the stored state occurs at a timing synchronized with the breathing action of the robot 1. Therefore, in the second normal mode, when a contact is detected at a timing synchronized with the breading action, the CPU 11 according to the variation 3 determines that the contact satisfies a predetermined condition and does not cause the robot 1 to perform a reactive action according to the contact.

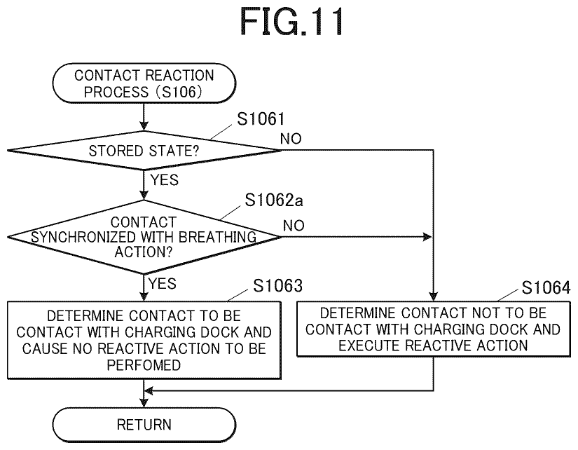

In the variation 3, instead of step S106 in the action control process in FIG. 6, a contact reaction process illustrated in FIG. 11 is executed. The contact reaction process in FIG. 11 corresponds to the contact reaction process in FIG. 9 according to the variation 1, with step S1062 changed to step S1062a. Hereinafter, differences from FIG. 9 will be described. In the contact reaction process in FIG. 11, if the CPU 11 determines that the robot 1 is in the stored state (“YES” in step S1061), the CPU 11 determines whether the contact detected in step S105 in FIG. 6 is detected at a timing synchronized with the breathing action of the robot 1 based on a detection result of the contact by the touch sensor 51 and the timing of the breathing action of the drive unit 40 (step S1062a). For example, when a contact is detected by the touch sensor 51 within a predetermined time after transmitting a control signal related to the breathing action to the drive unit 40, the CPU 11 determines that the contact is detected at a timing synchronized with the breathing action. The predetermined time is set to approximately the duration of one breathing action. If the CPU 11 determines that the contact is detected at a timing synchronized with the breathing action (“YES” in step S1062a), the CPU 11 determines that the detected contact is with the power feeder 80 according to the setting of the second operation mode and does not cause the robot 1 to perform a reactive action in response to the detected contact (step S1063). On the other hand, if the CPU 11 determines that the contact is not synchronized with the breathing action (“NO” in step S1062a), the CPU 11 determines that the detected contact is not with the power feeder 80 and causes the robot 1 to perform a predetermined reactive action according to the contact (step S1064). In addition, step S1061 in FIG. 11 may be omitted, and whether to execute a reactive action may be determined simply based on the determination result (in step S1062a) of whether a contact synchronized with the breathing action is detected.

Next, a variation 4 of the above-described embodiments will be described. Hereinafter, differences from the above-described embodiments will be described. In the second normal mode, the CPU 11 according to the variation 4 reduces the sensitivity of the microphone 55 to a predetermined first sensitivity, so that the rubbing sound with the power feeder 80 caused by the breathing action of the robot 1 is not detected by the microphone 55. The first sensitivity is set within a sensitivity range in which the rubbing sound is not detected (i.e., within a sensitivity range in which a sound with a volume within a reference range is not detected). It is preferable to set the first sensitivity as high as possible within the sensitivity range. In addition, in the second normal mode, the CPU 11 according to the variation 4 reduces the sensitivity of the touch sensors 51 to a predetermined second sensitivity, so that the contact with the power feeder 80 caused by the breathing action of the robot 1 is not detected by the touch sensors 51. The second sensitivity is set within a sensitivity range in which the contact with the power feeder 80 is not detected (i.e., within a sensitivity range in which a contact with an intensity within a reference range is not detected). It is preferable to set the second sensitivity as high as possible within the sensitivity range. In the second normal mode, both reducing the sensitivity of the microphone 55 to the first sensitivity and reducing the sensitivity of the touch sensors 51 to the second sensitivity may be performed, or only one of them may be performed.

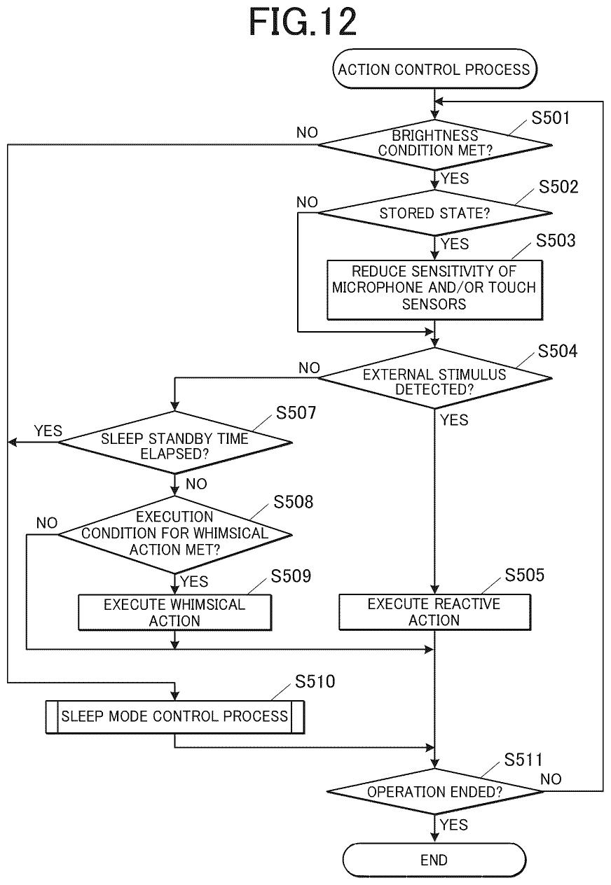

In the variation 4, instead of the action control process in FIG. 6, the action control process illustrated in FIG. 12 is executed. The action control process in FIG. 12 replaces steps S102 to S106 of the action control process in FIG. 6 with steps S502 to S505, and steps S501 and S507 to S511 in FIG. 12 are the same as steps S101 and S107 to S111 in FIG. 6. Hereinafter, differences from FIG. 6 will be described. In the action control process in FIG. 12, when the CPU 11 determines that the brightness condition is satisfied (“YES” in step S501), the CPU 11 determines whether the robot 1 is in the stored state (step S502). If the CPU 11 determines that the robot 1 is in the stored state (“YES” in step S502), the CPU 11 transmits a control signal to the microphone 55 and/or the touch sensors 51 to reduce the sensitivity of the microphone 55 to the first sensitivity and/or to reduce the sensitivity of the touch sensors 51 to the second sensitivity (step S503). If step S503 is completed, or if the CPU 11 determines that the robot 1 is in the non-stored state (“NO” in step S502), the CPU 11 determines whether an external stimulus has been detected based on detection results by the touch sensors 51 and the microphone 55 (step S504). If the CPU 11 determines that an external stimulus has been detected (“YES” in step S504), the CPU 11 causes the robot 1 to perform a reactive action according to the stimulus (step S505). When the sensitivity of the microphone 55 is reduced to the first sensitivity in step S503, only a sound louder than the rubbing sound with the power feeder 80 caused by the breathing action is detected by the microphone 55. This prevents the robot 1 from performing an unnatural action in response to the rubbing sound in step S505. When the sensitivity of the touch sensors 51 is reduced to the second sensitivity in step S503, only a contact with an intensity greater than the intensity of the contact with the power feeder 80 caused by the breathing action is detected by the touch sensors 51. This prevents the robot 1 from performing an unnatural action in response to the contact with the power feeder 80 in step S505.

As described above, the robot control apparatus 10 according to the present embodiments includes the CPU 11 that controls the robot 1, and the robot 1 includes the touch sensors 51 and the microphone 55 that detect an external stimulus. The CPU 11 determines the state of the robot 1 by a predetermined method. When the robot 1 is in the non-stored state (predetermined state) and a stimulus is detected by the touch sensor 51 or the microphone 55, the CPU 11 causes the robot 1 to perform a reactive action according to the stimulus. When the robot 1 is in the stored state (not in the predetermined state) and a stimulus that satisfies a predetermined condition is detected by the sensor, the CPU 11 does not cause the robot 1 to perform a reactive action according to the stimulus. This makes it possible to cause the robot 1 to perform a certain reactive action in response to a stimulus in the non-stored state, while preventing the robot 1 from performing the reactive action that appears unnatural in the stored state. Therefore, it is possible to prevent the robot 1 from performing an unnatural action, while causing the robot 1 to perform a natural action in response to its surroundings.

When the intensity of the stimulus is within a predetermined reference range, the CPU 11 determines that the stimulus satisfies the predetermined condition. This makes it possible to prevent the robot 1 from performing a reactive action in response to a stimulus with an intensity to which it is unnatural for the robot 1 to react in the stored state.

When the stimulus is a sound, the reference range is a reference range of the sound volume, and the reference range is defined to include the volume of a voice of a user speaking to the robot 1. This makes it possible to prevent the robot 1 from performing a reactive action in response to a sound with a volume comparable to the volume of a spoken voice in the stored state.

When the robot 1 is in the stored state and a stimulus that does not satisfy the predetermined condition is detected by the sensor, the CPU 11 causes the robot 1 to perform a reactive action according to the stimulus. This allows for the operation setting that includes causing the robot 1 to react to being petted firmly, even in the stored state in which a reactive action is suppressed, thus causing the robot 1 to behave like a living being.

When the robot 1 is outside the designated power feeder 80, the CPU 11 determines that the robot 1 is in the non-stored state (predetermined state). When the robot 1 is stored in the power feeder 80, the CPU 11 determines that the robot 1 is in the stored state (not in the predetermined state). According to this configuration, by suppressing a reactive action in the stored state, it is possible to cause the robot 1 to behave like a living being, such as “sleep or rest in the stored state”.

The power feeder 80 has a shape that can come into contact with at least a portion (for example, the side surface 1b) of the robot 1 when the robot 1 is stored therein. In this case, it is possible to prevent the robot 1 from performing an unnatural reactive action in response to a stimulus caused by the power feeder 80 coming into contact with the robot 1 in the stored state. In addition, by using the power feeder 80 as a holder, it is possible to prevent the robot 1 from performing an unnatural reactive action in response to a stimulus received while the battery 71 is being charged.

When the stimulus is a sound, if the volume of the sound is within a predetermined reference range, the CPU 11 determines that the sound satisfies the predetermined condition and causes the robot 1 to perform the breathing action in the stored state as a spontaneous action different from a reactive action. The reference range is defined to include the volume of the sound generated by the contact between the power feeder 80 and the robot 1 when the robot 1 performs the breathing action in the stored state. This makes it possible to prevent the robot 1 from performing an unnatural reactive action even when the rubbing sound with the power feeder 80 caused by the breathing action is detected.

In the variation 2, when a sound is detected at a timing synchronized with the breathing action, the CPU 11 determines that the sound satisfies the predetermined condition. This makes it possible to accurately determine whether the detected sound is the rubbing sound with the power feeder 80 caused by the breathing action, thereby suitably suppressing an unnatural reactive action of the robot 1. In addition, this makes it possible to cause the robot 1 to perform a reactive action in response to a sound other than the rubbing sound.

In the variation 1, when the intensity of the contact is within a predetermined reference range, the CPU 11 determines that the contact satisfies the predetermined condition and causes the robot 1 to perform the breathing action in the stored state. The reference range is defined to include the intensity of the contact between the power feeder 80 and the robot 1 caused by the breathing action of the robot 1 in the stored state. This makes it possible to prevent the robot 1 from performing an unnatural reactive action even when the contact with the power feeder 80 caused by the breathing action is detected.

In the variation 3, when a contact is detected at a timing synchronized with the breathing action, the CPU 11 determines that the contact satisfies the predetermined condition. This makes it possible to accurately determine whether the detected contact is with the power feeder 80 caused by the breathing action, thereby suitably suppressing an unnatural reactive action of the robot 1. In addition, this makes it possible to cause the robot 1 to perform a reactive action in response to a contact other than the contact with the power feeder 80.

Further, by causing the robot 1 to perform the breathing action that imitates breathing as a spontaneous action, it is possible to cause the robot 1 to behave like a living being.

The robot 1 according to the present embodiments includes the above-described robot control apparatus 10, the touch sensors 51, and the microphone 55. This allows the robot 1 to perform a natural action in response to its surroundings. In addition, by the method for controlling the robot 1 according to the present embodiments or by the CPU 11 executing the processes according to the programs 131 according to the present embodiments, it is possible to prevent the robot 1 from performing an unnatural action, while causing the robot 1 to perform a natural action in response to its surroundings.

The present disclosure is not limited to the above embodiments, and various modifications are possible. For example, in the above embodiments, as a stimulus that satisfies the predetermined condition, a sound with a volume within the reference range and a contact with an intensity within the reference range are exemplified, but the stimulus is not limited thereto. For example, when sound data detected by the microphone 55 is determined to be sound data of a voice of a person by a predetermined voice recognition process, it may be determined that the sound associated with the sound data satisfies the predetermined condition. Alternatively, conversely, when the sound data detected by the microphone 55 is determined not to be sound data of a voice of a person by the predetermined voice recognition process, it may be determined that the sound associated with the sound data satisfies the predetermined condition. In the latter case, in the second normal mode, it is possible to cause the robot 1 to react to a spoken voice of a user, while causing the robot 1 not to react any sound other than the spoken voice.

The breathing action is exemplified as a spontaneous action in the stored state, but the spontaneous action is not limited thereto. The spontaneous action may also include another action that imitates the robot 1 sleeping or resting.

The non-stored state is exemplified as a predetermined state, and the stored state is exemplified as a state other than the predetermined state, but the predetermined state is not limited thereto. A suitable state of the robot 1 may be defined as the predetermined state. In this way, when the robot 1 is in a state that is not the predetermined state, it is possible to prevent the robot 1 from performing a reactive action that is not appropriate to the state. For example, instead of the stored state, a state in which the robot 1 is held by a user (held state) may be defined as the predetermined state. In this case, when a contact between the clothes of the user and the exterior 200 (fur) of the robot 1 in the held state is detected, the robot 1 may be controlled so as not to perform a reactive action in the same manner as in the above embodiments.

An emotion parameter related to the emotion of the robot 1, a personality parameter related to the personality of the robot 1, and/or a growth parameter related to the growth of the robot 1 may be stored and updated successively in the storage unit 13, and the robot 1 may be operated according to the emotion parameter, the personality parameter, and/or the growth parameter. As an operation control of the robot 1 according to each parameter, a method described in JP 2022-142107A may be used, for example.

The configuration of the robot 1 is not limited to the configuration illustrated in FIGS. 1 to 3. For example, a robot imitating an existing living being such as a person, an animal, a bird, or fish, a robot imitating a non-existing living being such as a dinosaur, a robot imitating an imaginary living being, or the like may be used.

In the above embodiments, the robot control apparatus 10 that controls the robot 1 is disposed inside the robot 1 is exemplified, but the present disclosure is not limited thereto. The robot 1 may be controlled and operated by a robot control apparatus disposed outside the robot 1. The external robot control apparatus may include, for example, a smartphone, a tablet device, or a laptop. In this case, the robot 1 is operated according to a control signal received from the external robot control apparatus via the communication unit 60. The external robot control apparatus executes the functions executed by the robot control apparatus 10 in the above embodiments.

In the above description, an example has been disclosed in which a flash memory is used for the storage unit 13 as a computer-readable medium storing the programs according to the present disclosure, but the present disclosure is not limited thereto. As another computer-readable medium, an information recording medium such as a hard disk drive (HDD), a solid-state drive (SSD) or a CD-ROM may be applied. A carrier wave is also applied to the present disclosure as a medium that provides data of the programs according to the present disclosure via a communication line.

The detailed configuration and the detailed operation of each component of the robot 1 in the above embodiments can be appropriately changed without departing from the gist of the present disclosure.

Although the embodiments according to the present disclosure have been described, the scope of the present disclosure is not limited to the above-described embodiments and includes the scope of the invention as described in the claims and equivalents thereof.

1. A robot control apparatus comprising one or more processors configured to:
determine, in a predetermined manner, a state of a robot including a sensor that detects a stimulus from outside;
cause the robot to perform a reactive action corresponding to the stimulus in a case in which the sensor detects the stimulus and the robot is in a predetermined state; and
cause the robot not to perform the reactive action corresponding to the stimulus in a case in which the sensor detects the stimulus, the stimulus satisfies a predetermined condition, and the robot is not in the predetermined state.

2. The robot control apparatus according to claim 1, wherein the one or more processors determine that the stimulus satisfies the predetermined condition when an intensity of the stimulus is within a predetermined reference range.

3. The robot control apparatus according to claim 2, wherein
the stimulus is a sound, and
the reference range
is a reference volume range of the sound and
includes a volume of a voice of a user speaking to the robot.

4. The robot control apparatus according to claim 1, wherein the one or more processors cause the robot to perform the reactive action corresponding to the stimulus in a case in which the sensor detects the stimulus, the stimulus does not satisfy the predetermined condition, and the robot is not in the predetermined state.

5. The robot control apparatus according to claim 1, wherein the one or more processors determine
that the robot is in the predetermined state when the robot is outside a predetermined holder, and
that the robot is not in the predetermined state when the robot is stored in the holder.

6. The robot control apparatus according to claim 5, wherein the holder has a shape that comes into a contact with at least a portion of the robot when the robot is stored in the holder.

7. The robot control apparatus according to claim 5, wherein the holder includes a power feeder for charging a battery of the robot.

8. The robot control apparatus according to claim 6, wherein:
the stimulus is a sound;
the one or more processors:
determine that the sound satisfies the predetermined condition when a volume of the sound is within a predetermined reference range and;
cause the robot to perform a spontaneous action different from the reactive action when the robot is not in the predetermined state; and
the reference range includes the volume of the sound generated by a contact between the holder and the robot caused by the robot performing the spontaneous action when the robot is not in the predetermined state.

9. The robot control apparatus according to claim 6, wherein:
the stimulus is a sound; and
the one or more processors:
when the robot is not in the predetermined state, cause the robot to perform a spontaneous action different from the reactive action; and
determine that the sound satisfies the predetermined condition in a case in which the sound is detected at a timing synchronized with the spontaneous action.

10. The robot control apparatus according to claim 6, wherein:
the stimulus is a contact with the robot;
the one or more processors:
when an intensity of the contact is within a predetermined reference range, determine that the contact satisfies the predetermined condition; and,
when the robot is not in the predetermined state, cause the robot to perform a spontaneous action different from the reactive action; and
the reference range includes the intensity of the contact between the holder and the robot caused by the robot performing the spontaneous action when the robot is not in the predetermined state.

11. The robot control apparatus according to claim 6, wherein:
the stimulus is a contact with the robot;
the one or more processors:
when the robot is not in the predetermined state, cause the robot to perform a spontaneous action different from the reactive action; and
determine that the contact satisfies the predetermined condition in a case in which the contact is detected at a timing synchronized with the spontaneous action.

12. The robot control apparatus according to claim 8, wherein the spontaneous action is a breathing action that imitates breathing.

13. A robot comprising the robot control apparatus according to claim 1, and the sensor.

14. A method for controlling a robot that includes a sensor that detects a stimulus from outside, the method comprising:
determining a state of the robot in a predetermined manner;
causing the robot to perform a reactive action corresponding to the stimulus in a case in which the sensor detects the stimulus and the robot is in a predetermined state; and
causing the robot not to perform the reactive action corresponding to the stimulus in a case in which the sensor detects the stimulus, the stimulus satisfies a predetermined condition, and the robot is not in the predetermined state.

15. A non-transitory recording medium storing a computer-readable program, the program causing a computer to execute:
determining, in a predetermined manner, a state of a robot including a sensor that detects a stimulus from outside;
causing the robot to perform a reactive action corresponding to the stimulus in a case in which the sensor detects the stimulus and the robot is in a predetermined state; and
causing the robot not to perform the reactive action corresponding to the stimulus in a case in which the sensor detects the stimulus, the stimulus satisfies a predetermined condition, and the robot is not in the predetermined state.
